(19) United States
(12) Patent Application Publication
(10) Pub. No.: US 2014/0222980 A1
(43) Pub. Date: Aug. 7, 2014

(54) DEVICE MANAGEMENT APPARATUS, SYSTEM AND METHOD INCLUDING REMOTE CONFIGURATION OF DEVICE PREFERENCE SETTINGS

(71) Applicants: Kenji Hagiwara, Edgewater, NJ (US); Tom Haapanen, Heidelberg (CA); Arturo Hung Tse, San Jose, CA (US)

(72) Inventors: Kenji Hagiwara, Edgewater, NJ (US); Tom Haapanen, Heidelberg (CA); Arturo Hung Tse, San Jose, CA (US)

(73) Assignee: RICOH COMPANY, LTD., Tokyo (JP)

(21) Appl. No.: 13/758,082

(22) Filed: Feb. 4, 2013

(51) Int. Cl. H04L 12/24

(52) U.S. Cl. CPC H04L 41/0806
USPC 709/222

(57) ABSTRACT

Systems, apparatuses and methods are provided for managing information technology devices, to allow device settings to be remotely configured by a user in a user-friendly, efficient manner.

### TECHNICAL FIELD

This disclosure relates to tools (such as systems, apparatuses, methodologies, computer program products, etc.) for managing information technology devices, and more particularly such tools that enable remote configuration of device preference settings.

### BACKGROUND

In the current information age, information technology (IT) tools are extensively used in enterprises and other organizations in order to facilitate processing of documents and data. A typical IT environment includes assorted IT devices, such as computers, printers, scanners, multi-function devices (MFDs) and other network-connected or standalone devices. In some instances, device settings are uniformly applied all or most devices of the same type. On the other hand, there are many instances in which users of such IT devices are allowed to customize device settings (e.g., conditions under which alert notifications should be generated, method or type of user authentication to be used, etc.).

Some device manufacturer provide a device web page at which a user, by specifying a device ID, can check device status (such as check job status or history), control the device (e.g., check, modify, advance, or delete jobs on queue at device, interrupt jobs under processing, reset device), and/or otherwise configure device settings (such as specify security settings), through a web browser. However, such tools are device specific, requiring the user to configure one device at a time.

Likewise, a user may walk up to a specific device and use a device control panel, to configure device settings for that particular specific device only. Further, the settings that can be performed at a device control panel are typically somewhat limited.

Further, device management tools are available to allow a user to configure device settings. However, such tools typically rely on SNMP (Simple Network Management Protocol) or Web Service, each of which has provisions for only a limited number of settings.

Heretofore, there has been no solution that allows an administrator to configure settings for a large number of devices quickly and efficiently. Certain settings may be configurable via only one of the aforementioned conventional methods (for example, a particular setting may be configurable only via a method that requires the user to be at the device, leaving the user no option of configuring the device remotely), and depending on the settings that the user wishes to configure, the user may have to resort to different configuration methods, which may not be convenient for the user.

The aforementioned conventional methods leave a need for an improved approach for users to configure device settings of plural devices in a convenient manner.

### SUMMARY

In an aspect of this disclosure, there are provided tools (for example, a system, an apparatus, application software, etc.) to help a user of information technology (IT) devices in a networked IT system remotely configure device settings of such IT devices, in which a device settings management unit causes an embedded application to be installed on each specific network-connected device of a plurality of network-connected devices in the IT system. When the user specifies device preference settings for one or more of the network-connected devices, the device settings management unit causes the embedded application on each of said one or more network-connected devices to write the user-specified device preference settings on the respective one or more network-connected devices.

In another aspect, the embedded application collects device settings information from the specific network-connected device and communicates the device settings information to the device settings management unit, which displays device preference settings based on the device settings information to the user via a user interface.

In another aspect, the user interface of the device settings management unit displays all of the device preference settings of the specific network-connected device, and permits the user to specify and modify any of said all of the device preference settings of the specific network-connected device.

In another aspect, the user-specified device preference settings written on a particular network-connected device by the embedded application on the particular network-connected device include preference settings of one or more device users of the particular network-connected device.

In another aspect, the user-specified device preference settings written on a particular network-connected device by the embedded application on the particular network-connected device include service settings of the particular network-connected device by a service technician or administrator.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system for managing a plurality of network-connected devices, according to an exemplary embodiment;

FIG. 1B shows a block diagram of a system for managing a plurality of network-connected devices, according to another exemplary embodiment;

FIG. 2 shows a block diagram of a system for managing a plurality of network-connected devices, according to another exemplary embodiment;

FIG. 3 shows a block diagram of a system for managing a plurality of network-connected devices, according to another exemplary embodiment;

FIG. 4 shows a block diagram of a system for managing a plurality of network-connected devices, according to another exemplary embodiment;

FIG. 5 shows sample device settings information, according to an exemplary embodiment;

FIG. 6A shows a block diagram of an exemplary configuration of a device management apparatus, such as illustrated in FIG. 1A, according to an exemplary embodiment;

FIG. 6B shows a block diagram of an exemplary configuration of a terminal, such as illustrated in FIGS. 1-4, according to an exemplary embodiment;

FIG. 6C shows a block diagram of an exemplary configuration of a multi-function peripheral device, such as illustrated in FIGS. 2-4, according to an exemplary embodiment;

FIG. 7 shows sample screenshots of a user interface displayed to the user, according to an exemplary embodiment;

FIG. 8 shows sample screenshots of a user interface displayed to the user, according to an exemplary embodiment;

FIG. 9A shows a sample screenshot of a user interface displayed to the user, according to an exemplary embodiment;

FIG. 9B shows an exemplary configuration of device type information accessed by the device settings management unit, according to an exemplary embodiment;

FIG. 9C shows a sample screenshot of a user interface displayed to the user, according to an exemplary embodiment;

FIG. 9D shows an exemplary configuration of user preference settings information stored by the device settings management unit, according to an exemplary embodiment;

FIG. 10A shows a work flow of a method performed by a device management apparatus, such as illustrated in FIG. 1A, according to an exemplary embodiment;

FIG. 10B shows a work flow of a method performed by a device management apparatus, such as illustrated in FIG. 1A, according to an exemplary embodiment;

FIG. 11 shows a flowchart of a method performed by a device management apparatus, such as illustrated in FIG. 1A, according to an exemplary embodiment;

FIG. 12 shows a flowchart of a method performed by a device management apparatus, such as illustrated in FIG. 1A, according to an exemplary embodiment;

FIG. 13 shows a flowchart of a method performed by a device management apparatus, such as illustrated in FIG. 1A, according to an exemplary embodiment; and

FIG. 14 shows a flowchart of a method performed by a device management apparatus, such as illustrated in FIG. 1A, according to an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

Referring now to the drawings, wherein like reference numerals designate identical or corresponding parts throughout the several views, there is described tools (systems, apparatuses, methodologies, computer program products, etc.) for managing information technology devices, such as computers, printers, scanners, multi-function devices, and other network-connected, or standalone, devices (such as a projector unit, a video conference device, a telephone conference device, a shredding device, a stamp device, etc.), and for managing one or more networks to which a plurality of such information technology devices are connected.

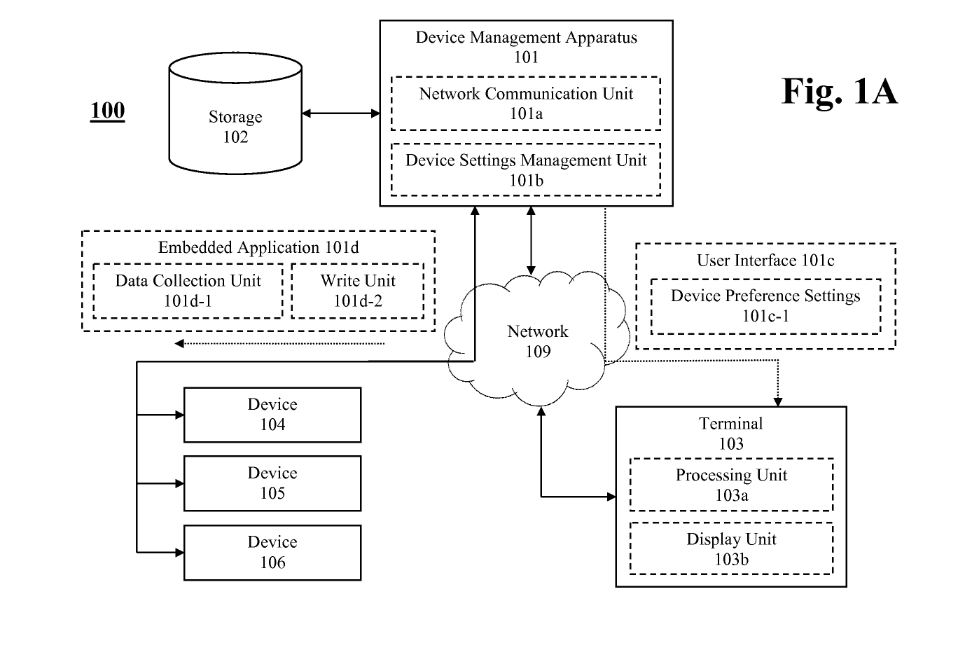

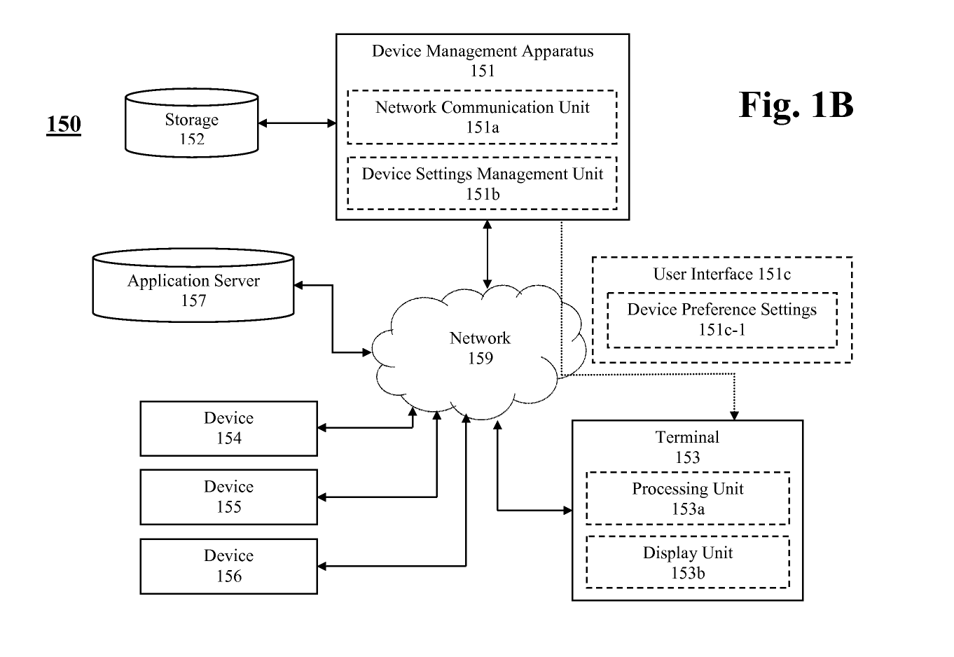

For example, FIG. 1A shows schematically a system 100 for managing a plurality of devices connected to a network, according to an exemplary embodiment. The system 100 includes a device management apparatus 101, a storage 102, a terminal 103 and network-connected devices 104-106, all of which are interconnected by a network 109.

The device management apparatus 101 includes a network communication unit 101a which communicates through the network 109 with the network-connected devices 104-106, and a device settings management unit 101b, which causes a user interface 101c to be displayed on the terminal 103 and causes an embedded application 101d to be installed on each of the network-connected devices 104-106.

The network communication unit 101a allows the device management apparatus 101 to communicate through the network 109, such as with the network-connected devices 104-106 and the terminal 103. The network communication unit 101a is configured to communicate with any particular device amongst plural heterogeneous devices that may be included in the system 100 in a communication format native to the particular device. For example, in the system 100, the network communication unit 101a communicates with each of the network-connected devices 104-106 in a communication format established by the respective manufacturers/vendors of the network-connected devices 104-106. The network communication unit 101a may determine an appropriate communication format native to the particular device by any of various known approaches. For example, the application processing unit 20c may refer to a database or table, maintained internally or by an outside source, to determine an appropriate communication format native to the device. As another example, the network communication unit 101a may access an Application Program Interface (API) of the particular device, in order to determine an appropriate communication format native to the device.

The device settings management unit 101b causes the network communication unit 101a to communicate through the network 109 with the network-connected devices 104-106 to cause the embedded application 101d to be installed on each of the network-connected devices 104-106.

The embedded application 101d is a software component dedicated to handle specific tasks, including collecting device settings information from the network-connected device on which the embedded application 101d is installed, and writing device preference settings specified by a user onto the network-connected device. In the example of FIG. 1A, the embedded application 101d includes a data collection unit 101d-1 and a write unit 101d-2 for performing such tasks.

The data collection unit 101d-1 collects device settings information of the network-connected device on which the embedded application 101d is installed (i.e. network-connected devices 104-106).

Many printers and other devices store data indicating their attributes or properties in a Management Information Base (MIB). The MIB may conform with the SNMP (Simple Network Management Protocol), and device settings information can be obtained directly from the MIB through SNMP queries. The device settings information can also be obtained using other known protocols. In this way, the data collection unit 101d-1 is configured to collect the device settings information from the network-connected device 104 on which the embedded application 101d is installed and to transmit the collected device settings information to the device management apparatus 101.

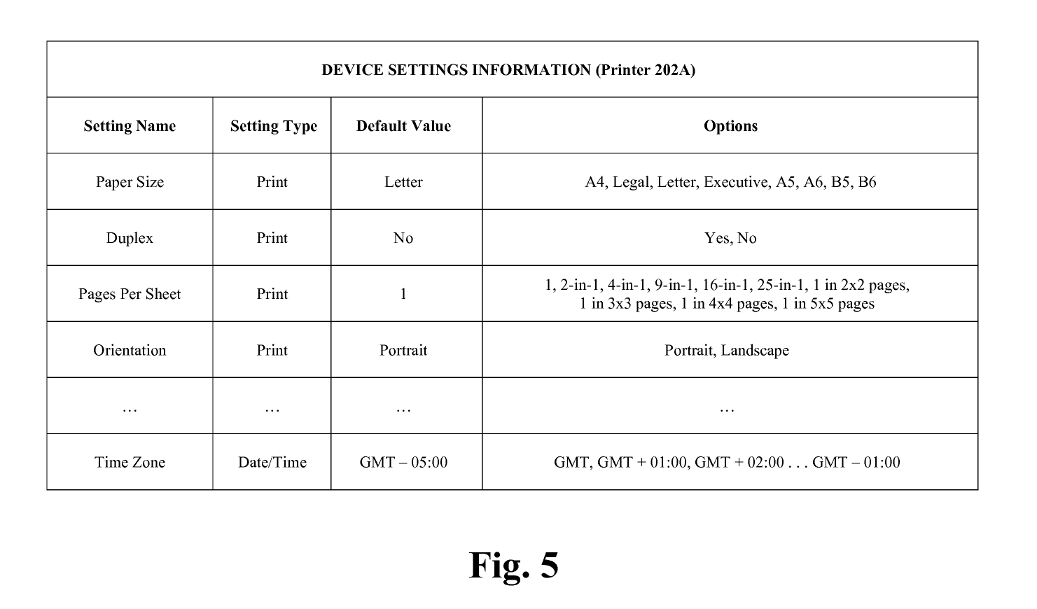

An example of device settings information collected by the embedded application 101d from the network-connected devices 104-106 is illustrated in FIG. 5. As seen in FIG. 5, the device settings information for each network-connected device may include a variety of attributes such as setting name, setting type, default value of the setting, and the options selectable for the setting. The information depicted in FIG. 5 is merely exemplary, and a wide range of other device preference settings, such as network settings, authentication settings, log settings, image settings, print settings and etc., may be included in the device settings information collected by the data settings management units.

As non-limiting examples, “device group” indicating the group to which the particular network-connected device belongs in a network environment, “SNMPv3” indicating whether SNMPv3 (Simple Network Management Protocol, version 3) is enabled, “reception protocol” indicating a protocol used for e-mail reception, “memory overflow” indicating an action to perform in the event of a memory overflow (e.g. do not print), “toner saving” indicating whether a toner saving mode is enabled, “firmware update” indicating whether firmware update is permitted, and so forth.

The device settings information collected and transmitted by the embedded application 101d can be stored in an internal storage resident in the device management apparatus 101. Alternatively, the device settings information can be stored externally in a storage unit connected to the device management apparatus (e.g. storage 102) or accessible via the network 109, and retrieved as needed.

The write unit 101d-2 writes user-specified device preference settings received from the device settings management unit 101b via the network communication unit 101a onto the network-connected devices 104-106. For example, the user-specified device preference settings may include a list of parameters configurable on the network-connected device 103 and a corresponding value for each parameter. In such case, the write unit 101d-2 may set the value of each of such parameters on the network-connected device 103 to the corresponding value included in the user-specified device preference settings. The network-connected device 103 may maintain a database which stores such parameters and corresponding values. A separate user profile including all of the device preference settings of the network-connected devices 104-106 may be maintained for each of a plurality of users of the network-connected devices 104-106.

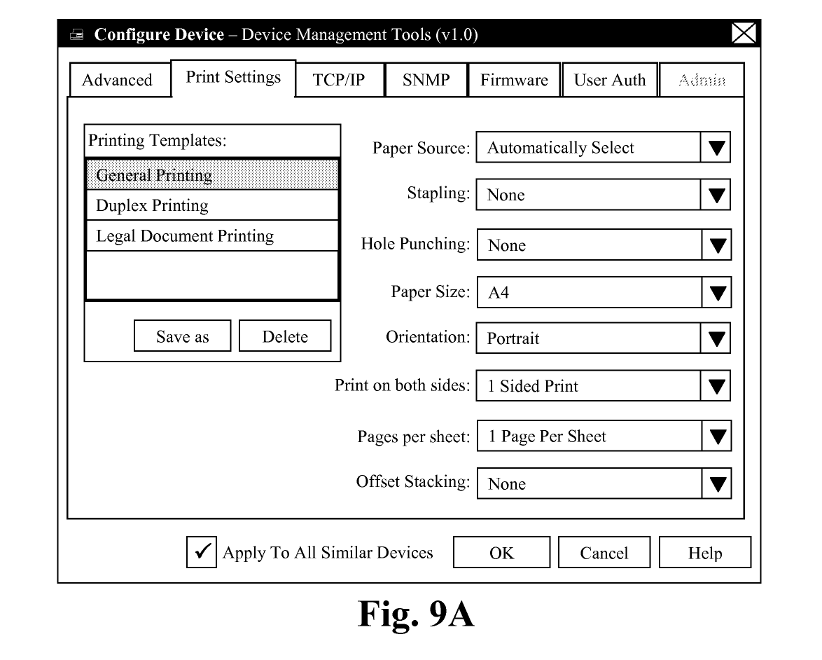

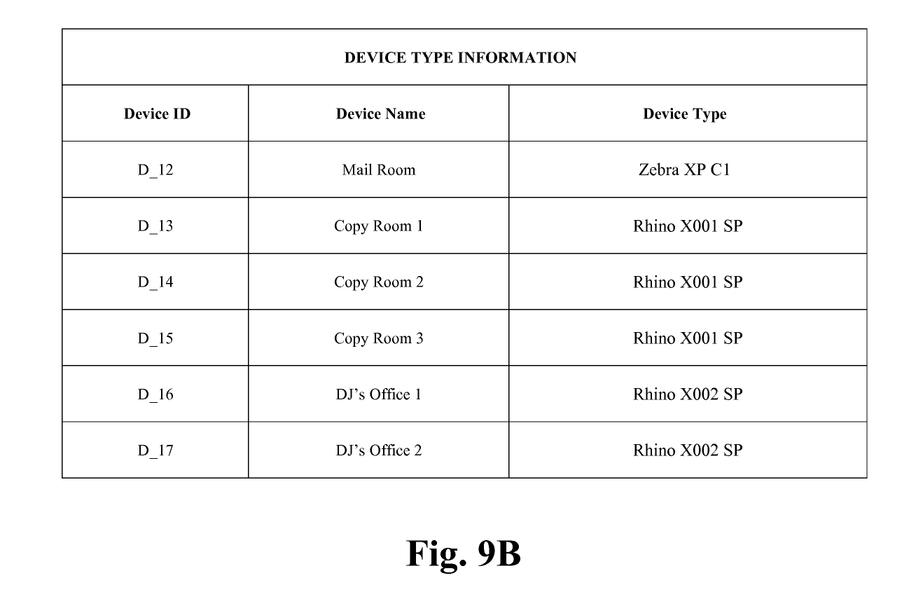

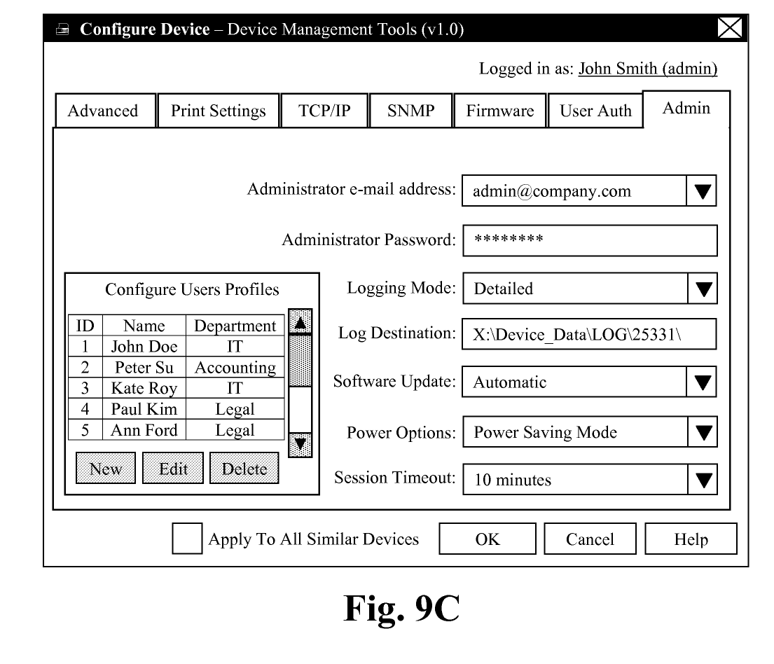

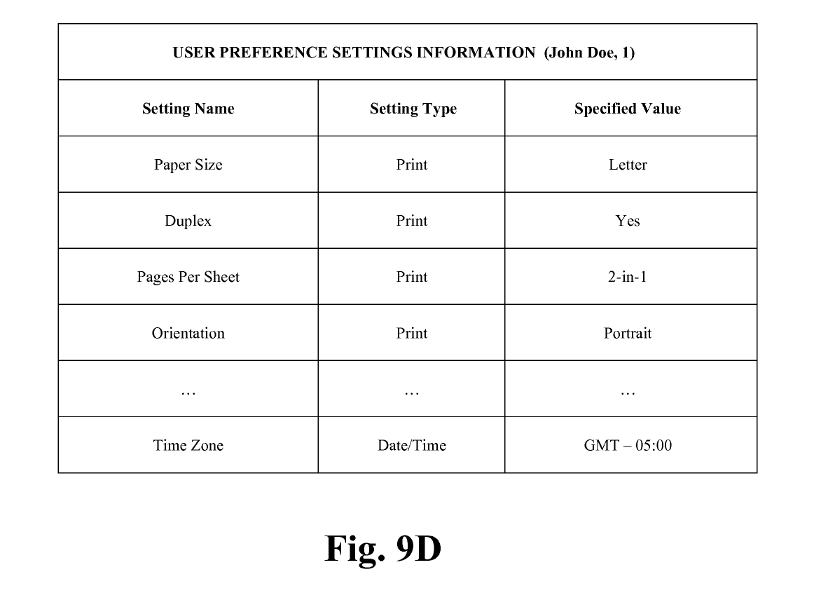

The device settings management unit 101b also includes the user interface 101c, via which device preference settings of the network-connected devices 104-106 (extracted from the device settings information collected by the embedded application 101d) are displayed to the user at the terminal 103. As shown in FIG. 1A, the user interface 101c includes device preference settings 101c-1 which can be configured by the user at the terminal 103. For example, the user interface 101c may be displayed on a display unit 103b of the terminal 103, allowing the user at the terminal 103 to configure the various device preference settings displayed in the user interface 101c. A sample user interface for configuring such device preference settings is shown in FIG. 9A.

When the user specifies the device preference settings for the network-connected devices 104-106, the device settings management unit 101b receives the user-specified device preference settings and causes the user-specified device preference settings to be communicated to the embedded application 101d, which writes the user-specified device preference settings on the network-connected devices 104-106.

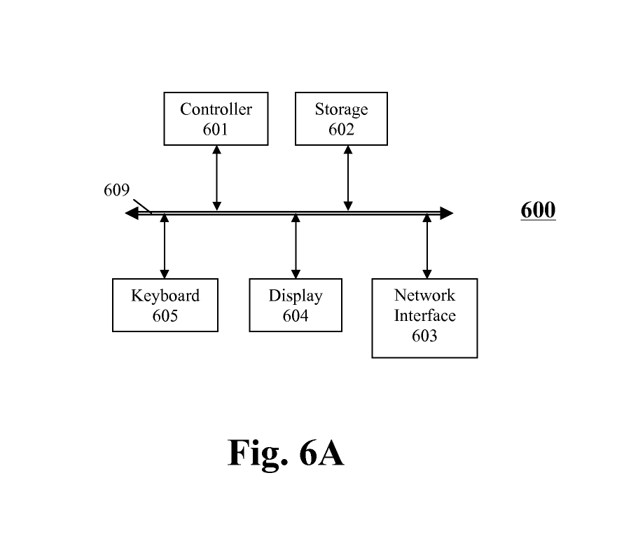

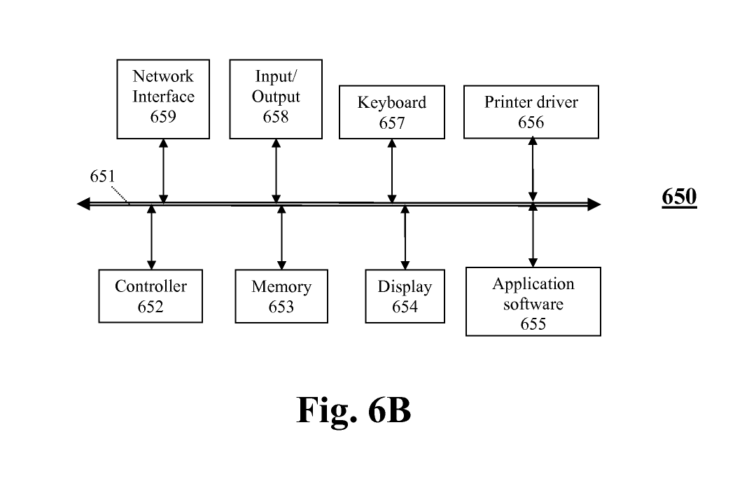

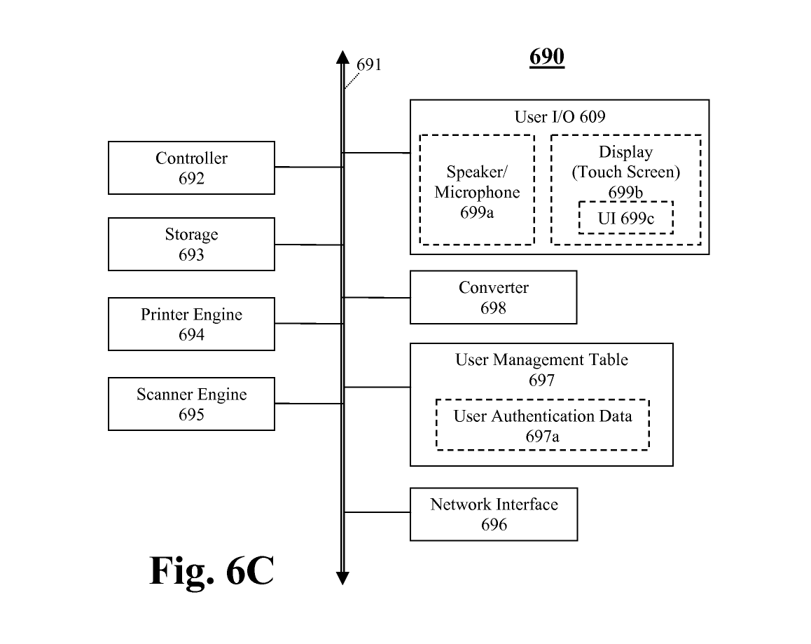

The terminal 103 includes a processing unit 103a and a display unit 103b. For example, the device settings management unit 101b causes the display unit 103b to display the user interface 101c. The user at the terminal 103 (e.g. a user of the network environment managed by the device management apparatus 101) can configure the device preference settings displayed via the user interface 101c. The terminal 103 is further described infra with reference to FIG. 6B.

The network-connected devices 104-106 may include, for example, a printer, a scanner and/or a multi-function device (MFD). While this example of this disclosure simply refers to network-connected devices 104-106 in the interest of brevity, the aspects of this disclosure are applicable to a network environment having an arbitrary number of devices.

It should be appreciated that while the terminal 103 and the network-connected devices 104-106 are shown in the example of FIG. 1A, the system 100 can include more terminals and network-connected devices. Indeed, the network management system of this disclosure is preferably configured to be scalable such that terminals and IT devices can be added to the system as desired and needed (e.g. to serve more users).

The network 109 can be a local area network, a wide area network or any type of network such as an intranet, an extranet (for example, to provide controlled access to external users, for example through the Internet), the Internet, etc., or a combination thereof. Further, other communications links (such as a virtual private network, a wireless link, etc.) may be used as well for the network 109. In addition, the network 109 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 1B shows schematically a system 150 for managing a plurality of devices connected to a network, according to an exemplary embodiment. The system 150 includes a device management apparatus 151, a storage 152, a terminal 153, network-connected devices 154-156 and an application server 157, all of which are interconnected by a network 159.

The application server 157 is a server that stores embedded applications to be sent to the various devices (e.g. 154-156) in the system 150. The application server 157 is connected to the device management apparatus 151 via the network 159, and upon the request of the device settings management unit 151b, the application server 157 transmits an embedded application to a destination network-connected device and installs the embedded application on the destination network-connected device.

Otherwise, operations of the elements of the system 150 are similar to those discussed in connection with the corresponding elements of the system 100 of FIG. 1A.

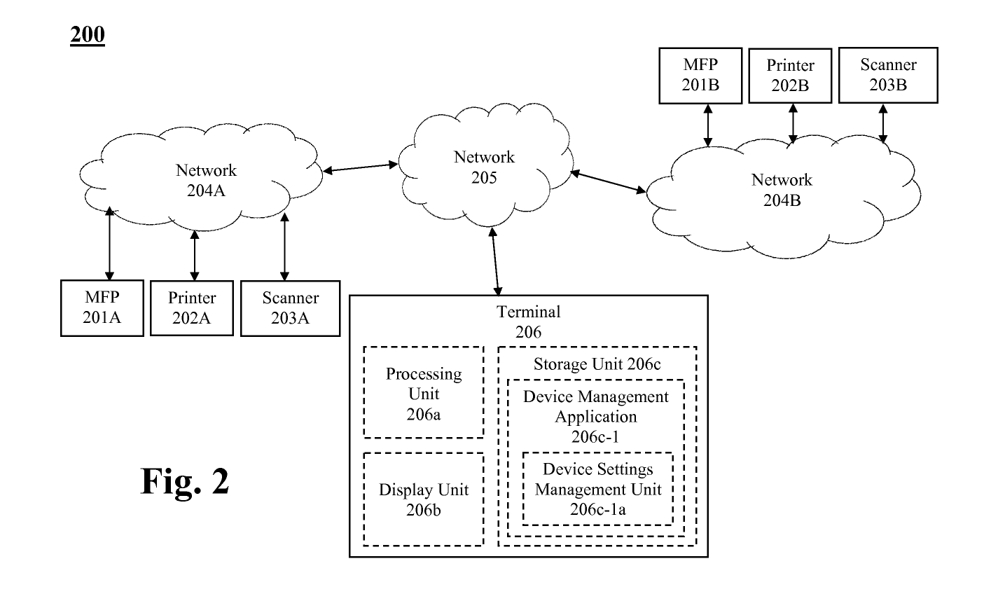

With reference to FIG. 2, a system for managing a plurality of network-connected devices, according to another exemplary embodiment, is described below.

The example of FIG. 2 includes a system 200 which includes a multi-function peripheral (MFP) 201A, a printer 202A and a scanner 203A, all of which are interconnected by a network 204A (collectively “Network A”); an MFP 201B, a printer 202B and a scanner 203B, all of which are interconnected by a network 204B (collectively “Network B”); and a terminal 206, which is connected to a network 205 which is connected to the networks 204A and 204B.

The terminal 206 includes a processing unit 206a, a display unit 206b and a storage unit 206c. The operations of the processing unit 206a and the display unit 206b are similar to those of the processing unit 103a and the display unit 103b discussed in connection with FIG. 1A, respectively. The storage unit 206c includes a device management application 206c-1 having a device settings management unit 206c-1a. Upon the execution of the device management application 206c-1 by the processing unit 206a, a user interface similar to that described with reference to FIG. 1A is displayed on the display unit 206b. When the device management application 206c-1 receives a user request (e.g. from a user at the terminal 206) to configure the device preference settings of one or more of the network-connected devices in Networks A and B, the device settings management unit 206c-1a of the device management application 206c-1 communicates with the network-connected devices (e.g. MFPs 201A and 201B, printers 202A and 202B, and scanners 203A and 203B) in Networks A and B to cause an embedded application corresponding to the specific device to be installed on each of the network-connected devices in Networks A and B.

Thus, a user can remotely configure device preference settings of a plurality of network-connected devices over multiple networks. It should be appreciated that although only two networks (Networks A and B) are shown in the example of FIG. 2, the system 200 is not limited to such configuration and the terminal 206 can be configured such that a user at the terminal 206 may configure device preference settings of a plurality of network devices in any arbitrary number of networks.

Otherwise, operations of the elements of the system 200 are similar to those discussed in connection with the corresponding elements of the system 100 of FIG. 1A.

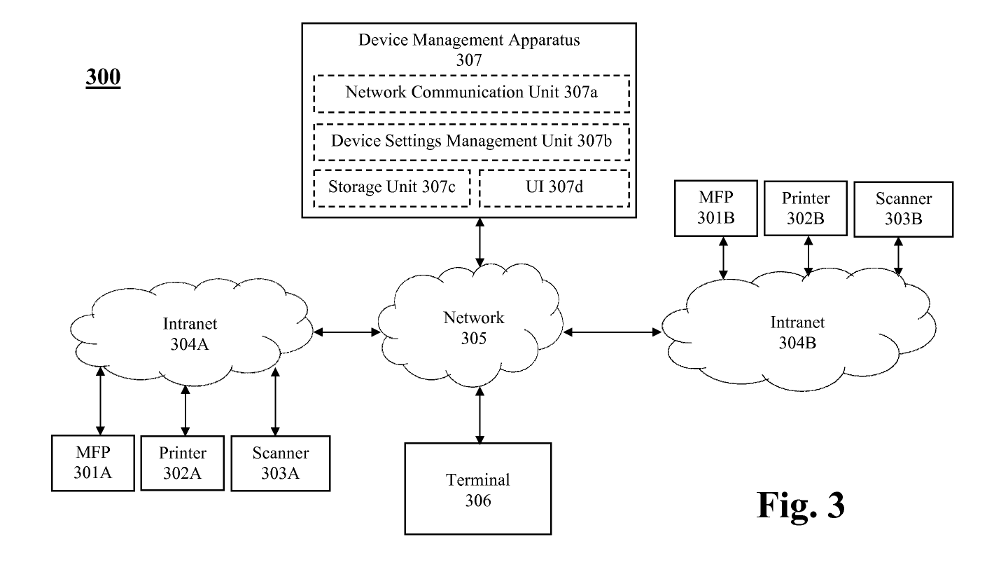

With reference to FIG. 3, a system for managing a plurality of network-connected devices, according to another exemplary embodiment, is described below.

The example of FIG. 3 includes a system 300 which includes an MFP 301A, a printer 302A and a scanner 303A, all of which are interconnected by an intranet 304A (collectively “Network A”); an MFP 301B, a printer 302B and a scanner 303B, all of which are interconnected by an intranet 304B (collectively “Network B”); and a terminal 306 and a device management apparatus 307, which are interconnected by a network 305. The network 305 is connected to the intranets 304A and 304B. The device management apparatus 307 includes a network communication unit 307a, a device settings management unit 307b, a storage unit 307c and a user interface 307d.

For example, each of the Networks A and B respectively connected by the intranets 304A and 304B may represent a regional office of a global or national enterprise having multiple regional offices.

In the example of FIG. 3, the user interface 307d via which the user may configure device settings of the various network devices in the network environment is provided on the device management apparatus 307. The device settings management unit 307b communicates with the network-connected devices of Networks A and B (e.g. MFPs 301A and 301B, printers 302A and 302B, and scanners 303A and 303B) to install an embedded application on each of the network-connected devices for which the user has requested to configure device preference settings (via the user interface 307d), and to cause the embedded application to write user-specified device preference settings on such network-connected devices.

As discussed above, the storage unit 307c may store one or more copies of the embedded application and/or device settings information collected by the embedded application installed on the network-connected devices.

Otherwise, operations of the elements of the system 300 are similar to those discussed in connection with the corresponding elements of the system 100 of FIG. 1A.

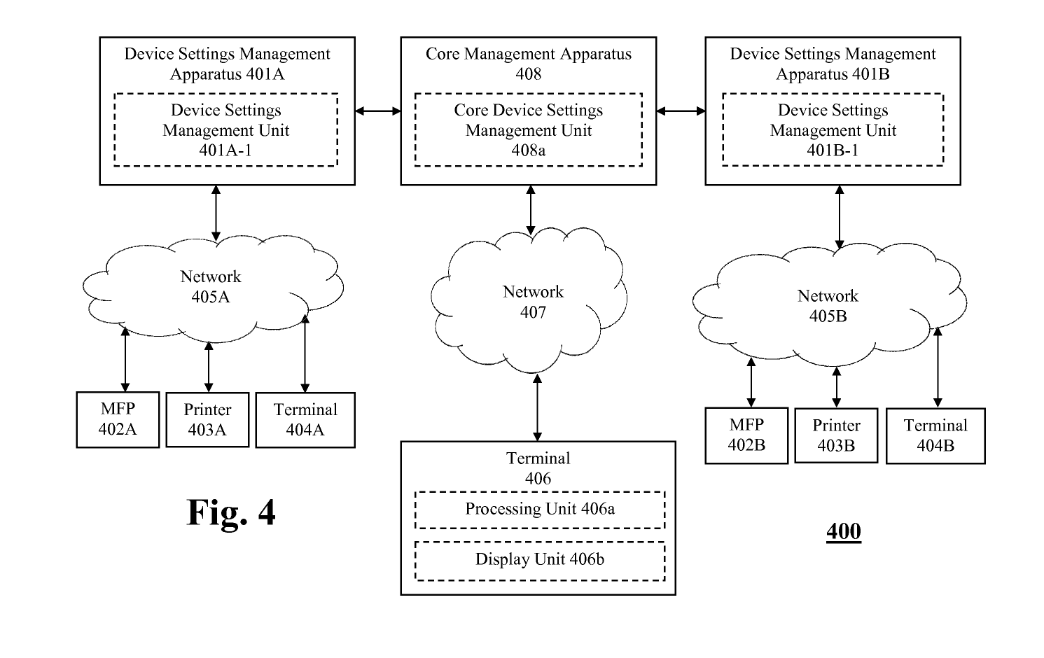

With reference to FIG. 4, a system for managing a plurality of network-connected devices, according to another exemplary embodiment, is described below.

The example of FIG. 4 includes a system 400 which includes a device settings management apparatus 401A including a device settings management unit 401A-1, an MFP 402A, a printer 403A and a terminal 404A, all of which are interconnected by a network 405A (collectively “Network A”); a device settings management apparatus 401B including a device settings management unit 401B-1, an MFP 402B, a printer 403B and a terminal 404B, all of which are interconnected by a network 405B (collectively “Network B”); a terminal 406 and a core management apparatus 408 including a core device settings management unit 408a, which are interconnected by a network 407 (collectively “Network C”). The core management apparatus 408 is connected to the device settings management apparatuses 401A and 401B.

Each of terminals 404A and 404B may be a user terminal via which a user interface for configuring device preference settings of the network-connected devices of the respective networks is displayed. For example, when the user at the terminal 404A specifies device preference settings for the printer 403A, the device settings management unit 401A-1 transmits the user-specified device preference settings to the embedded application installed on the printer 403A and causes the user-specified device preference settings to be written on the printer 403A.

In addition, the user at the terminal 406 may also configure the network-connected devices in Networks A and B via the core device settings management apparatus 408. When the user at the terminal 406 specifies device preference settings for the printer 403A, the core device settings management unit 408a communicates the user-specified device preference settings to the device settings management unit 401A-1, which in turn transmits, as discussed above, the user-specified device preference settings to the embedded application installed on the printer 403A to be written on the printer 403A.

For example, the user at the terminal 404A may be a user at the local office of an enterprise, each of Networks A and B representing a separate office, and the user at the terminal 406 may be an administrator who is responsible for managing the entire enterprise network and authorized to remotely configure device preference settings on the network-connected devices in multiple regional networks.

The core device settings management unit 408a and/or the device settings management units 401A-1 and 401B-1 may be realized by a computer program product including a computer-usable, non-transient medium (such as a disk storage apparatus) having instructions tangibly embodied therein that are executed by a computer. Thus, it should be understood that the core device settings management unit 408a and/or the device settings management units 401A-1 and 401B-1 may be executed on a computer. While the core device settings management unit 408a and/or the device settings management units 401A-1 and 401B-1 are shown as being external to the network devices, the core device settings management unit 408a and/or the device settings management units 401A-1 and 401B-1 may in fact be executed on a client terminal and/or network-connected device.

The core management apparatus 408 and/or the device settings management apparatuses 401 may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

As an example, the core device settings management unit 408a may be used by a super administrator who is in charge of managing an entire enterprise network which may include plural regional networks. In contrast, each local administrator may be in charge of managing one of such plural regional networks via the device settings management units 401A-1 and 401B-1.

In the example of FIG. 4, only three networks (Networks A-C) are shown in the interest of brevity, but the system 400 is not limited to such configuration. The core management apparatus 408 may be connected to any arbitrary number of device settings management apparatuses 401 and other devices (e.g. terminal 406).

Otherwise, operations of the elements of the system 400 are similar to those discussed in connection with the corresponding elements of the system 100 of FIG. 1A.

FIG. 6A shows an exemplary configuration of a computing device that can be configured (for example, through software) to operate (at least in part) as the core management unit 408 of FIG. 4 and/or device settings management apparatuses 401 illustrated in FIG. 4. As shown in FIG. 6A, the management unit 600 includes a controller (or central processing unit) 601 that communicates with a number of other components, including memory or storage part 602, network interface 603, display 604 and keyboard 605, by way of a system bus 609.

The management unit 600 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In the management unit 600, the controller 601 executes program code instructions that control device operations. The controller 601, memory/storage 602, network interface 603, display 604 and keyboard 605 are conventional, and therefore in order to avoid occluding the inventive aspects of this disclosure, such conventional aspects will not be discussed in detail herein.

The management unit 600 includes the network interface 603 for communications through a network, such as communications through the network 209 with the network-connected devices 104-106 in FIG. 1A. However, it should be appreciated that the subject matter of this disclosure is not limited to such configuration. For example, the management unit 600 may communicate with client terminals through direct connections and/or through a network to which some components are not connected. As another example, the management unit 600 does not need to be provided by a server that services terminals, but rather may communicate with the devices on a peer basis, or in another fashion.

The core device settings management unit and/or the device settings management units of the present disclosure are not limited to a server or computer, but can be manifested in any of various devices that can be configured to communicate over a network and/or the Internet.

An example of a configuration of the terminal 103 of FIG. 1A and/or the terminals 404 of FIG. 4 (for example, as a computer) is shown schematically in FIG. 6B. In FIG. 6B, computer 650 includes a controller (or central processing unit) 652 that communicates with a number of other components, including memory 653, display 654, keyboard (and/or keypad) 657, other input/output (such as mouse, touchpad, stylus, microphone and/or speaker with voice/speech interface and/or recognition software, etc.) 658, network interface 659, print driver 656 and application software 655, by way of an internal bus 651.

The memory 653 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 659 provides a connection (for example, by way of an Ethernet connection or other network connection which supports any desired network protocol such as, but not limited to TCP/IP, IPX, IPX/SPX, or NetBEUI) to the network to which the computer 650 is connected (e.g. network 109 of FIG. 1A).

Print driver 656 and application software 655 are shown as components connected to the internal bus 651, but in practice are typically stored in storage media such as a hard disk or portable media, and/or received through the network, and loaded into memory 653 as the need arises.

Depending on the type of the particular terminal device, one or more of the components shown in FIG. 6B may be missing. For example, a particular mobile phone may be missing the print driver 656 and the keyboard 657.

Additional aspects or components of the computer 650 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

Each of the network-connected devices 104-106 of FIG. 1A (or other network-connected devices described in the present disclosure) may be any device including but not limited to a personal, notebook or workstation computer, a terminal, a kiosk, a personal digital assistant (PDA), a tablet computing device, a smartphone, a scanner, a printer, a facsimile machine, a multi-function device (MFD), a server, a mobile phone or handset, another information terminal, etc. Each network-connected device may be configured with software allowing the network-connected device to communicate through a network with a device settings management unit and/or a core device settings management unit described in the present disclosure.

FIG. 6C shows a schematic diagram of a configuration of a network-connected device as an MFD, according to an exemplary embodiment, which can be any apparatus (including a microprocessor chip or a collection of devices having varying degree of integration) that has the ability to perform two or more functionalities.

The MFD 690 shown in FIG. 6C includes a controller 692, and various elements connected to the controller 692 by an internal bus 691. The controller 692 controls and monitors operations of the MFD 690. The elements connected to the controller 692 include storage 693 (for example, random access memory, read-only memory, hard disk drive, portable storage media drive such as for optical discs, magnetic discs, magneto-optical discs, etc., semiconductor memory cards, combinations of storage media, etc.), printer engine 694, scanner engine 695, network interface (I/F) 696, converter 698 for converting data from one format to another format (for example, a format suitable for printing, faxing, e-mailing, etc.), and user I/O (Input/Output) 699. The controller 692 also utilizes information stored in user management table 697 to authenticate the user and control user access to the functionalities of the MFD 690.

Storage 693 can include one or more storage parts or devices [e.g. a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 693 and executed by the controller 692 to carry out the instructions. Such instructions can include instructions for performing specified functions (such as printing, scanning, faxing, copying, e-mailing, etc.) of the MFD 690, to enable the MFD 690 to interact with a terminal, as well as perhaps other external devices, through the network interface 696, and to control the converter 698, access data in the user management table 697, and interactions with users through the user I/O 699.

The network interface 696 is utilized by the MFD 690 to communicate with other network-connected devices such as a terminal or a device settings management unit (e.g., device management apparatus 101 of FIG. 1A) and receive data requests, print jobs, user interfaces, and etc.

The user I/O 699 includes one or more display screens that display, under control of controller 692, information allowing the user of the MFD 690 to interact with the MFD 690. The display screen can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFD 690, so as to allow the operator to interact conveniently with services provided on the MFD 690, or with the MFD 690 serving as terminal for accessing electronic data or other content through the network. User interfaces or other contents received through the network via the network interface 696 can be displayed on the display screen.

The display screen does not need to be integral with, or embedded in, a housing of the MFD 690, but may simply be coupled to the MFD 690 by either a wire or a wireless connection. The user I/O 699 may include keys and/or buttons (such as graphical keys or buttons, or other graphical elements, of a GUI on a touchscreen display) for inputting information or requesting various operations. Alternatively, the user I/O 699 and the display screen may be operated by a keyboard, a mouse, a remote control, voice recognition (e.g., through a speaker/microphone 699a), or eye-movement tracking, or a combination thereof.

Printer engine 694, scanner engine 695 and network interface 696 are otherwise conventional, and therefore, a detailed description of such conventional aspects is omitted in the interest of clarity and brevity.

The MFD 690 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multi-function peripheral devices can play a prominent role to convert hardcopy documents to electronic documents.

As discussed above, the MFD 690 may also operate as a device management apparatus (e.g. device management apparatus 101 of FIG. 1A). The operation of such device management apparatus according to an exemplary embodiment is described supra with reference to FIG. 1A.

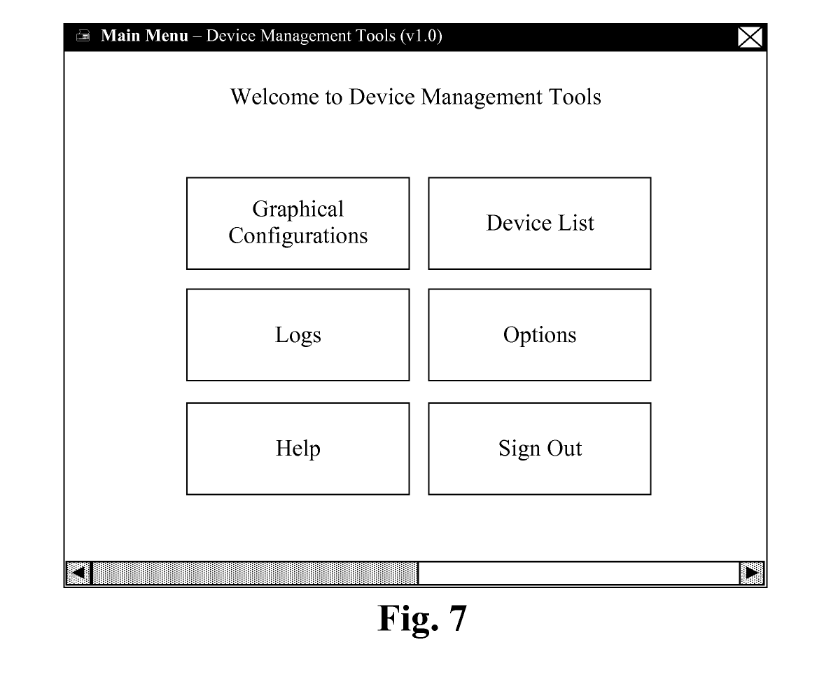

FIG. 7 shows a screenshot of a main menu in an application software product for providing device management services, according to an exemplary embodiment. Such main menu screen is displayed on the terminal device of the user when the user successfully signs in, for example, by providing login credentials. In the example of FIG. 7, the main menu screen has the following buttons: “graphical configurations” for displaying the graphical configurations (e.g. customized view of the network environment, which includes graphs and tables), “device list” for displaying the list of network devices in the network environment, “logs” for displaying a log file which records various events that occur in the network environment managed by the device management application, “options” for allowing the user to configure various settings that govern the operation of the device management application, and “sign out” for signing out of the device management application.

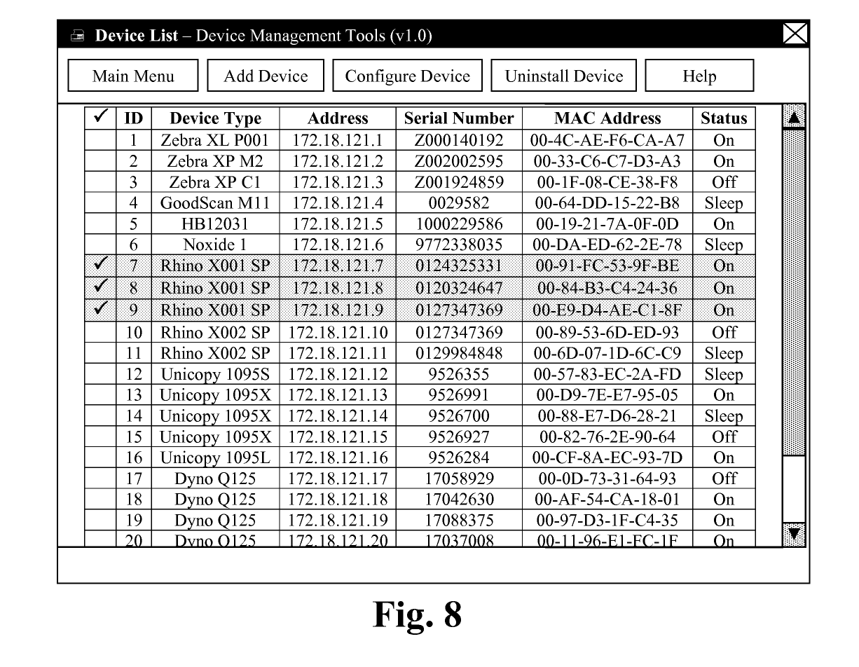

FIG. 8 shows a screenshot of a user interface (UI) displayed upon activating the “device list” button of FIG. 7, according to an exemplary embodiment. As shown in FIG. 8, a list of devices connected to the network (or networks accessible by the user) is displayed to the user. At the top of the screen, buttons are provided for returning to the main menu screen (“main menu”), adding a new network device (“add device”), configuring one or more existing devices (“configure device”), uninstalling one or more existing devices (“uninstall device”), and obtaining additional details regarding the device list (“help”).

The device list UI allows the user to select one or more devices from the list and configure or uninstall the selected devices. As shown in FIG. 8, the selection of a device is indicated by a checkmark in the leftmost column of the device list. Multiple devices may be configured or uninstalled at a time by selecting the plurality of devices that the user wishes to configure or uninstall and activating the “configure device” or “uninstall device” button.

For example, when the user activates the “configure device” button, a user interface for device configuration is displayed to the user, as shown in FIG. 9A. In the example of FIG. 9A, the device configuration UI includes a plurality of selectable tabs at the top (e.g. “advanced”, “print settings”, “TCP/IP”, “SNMP”, “firmware”, “user auth” and “admin”), and each tab represents a category of device preference settings that can be configured by the user. In FIG. 9A, the “print settings” tab is selected, which provides numerous printing templates and parameters that can be configured by the user. The user can save a set of settings as a new template for future access by configuring the parameters displayed in the right portion of the UI and activating the “save as” button. Previously saved templates can be deleted by activating the “delete” button. If the user wishes to apply the current device preference settings to the currently selected device and to all other devices that are similar (e.g. same manufacturer and model), the “apply to all similar devices” checkbox can be checked before activating the “OK” bottom.

For example, when the “apply to all similar devices” checkbox is checked and the “OK” button is activated, the device settings management unit accesses a table including a list of devices and the corresponding device types (e.g. such as shown in FIG. 9B), retrieves all the devices having the same device type as the device selected by the user, and causes the embedded application on each of such devices to write the user-specified device preference settings to the respective network-connected device.

In the example of FIG. 9A, the “admin” tab is grayed out because the user does not have sufficient privileges to configure the device preference settings categorized under the “admin” tab. For an authorized user having administrator privileges, the “admin” tab may be selectable, as shown in FIG. 9C. As discussed above, a separate user profile for each of the plurality of users of the network-connected devices may be maintained. For example, the user profile of a particular user may include device preference settings previously specified by the user and the status of the user (e.g. user, network administrator, device administrator, etc.). As shown in FIG. 9C, the user interface may indicate the name of the user who is currently logged in (“John Smith”), and the status of the user (“admin”).

In addition, the “admin” tab may allow the admin user to configure the user profiles maintained for the users of the device management system. As shown in FIG. 9C, the “admin” tab shows a list of users whose profiles are stored, and the admin user may use the “add”, “edit” and “delete” buttons to add a new user profile, edit any of the existing profiles, and delete any of the existing profiles, respectively.

Such user profiles may be stored by the device settings management unit (or a core device settings management unit) in an internal storage (e.g. storage 307c of FIG. 3), or in an external storage directly connected to a device settings management apparatus (e.g. storage 102 of FIG. 1), or in a storage unit accessible by the device settings management unit (and other devices in the network environment) via a network.

The user profile for each particular user may include the preference settings information specified by the particular user, such as shown in FIG. 9D. The table of FIG. 9D shows an exemplary configuration of the user preference settings information stored for John Doe (whose user ID is 1).

The user interface shown in FIGS. 9A and 9C is merely an example of how various device preference settings may be displayed for user configuration, and the device preference settings may be presented to the user in a variety of other different ways.

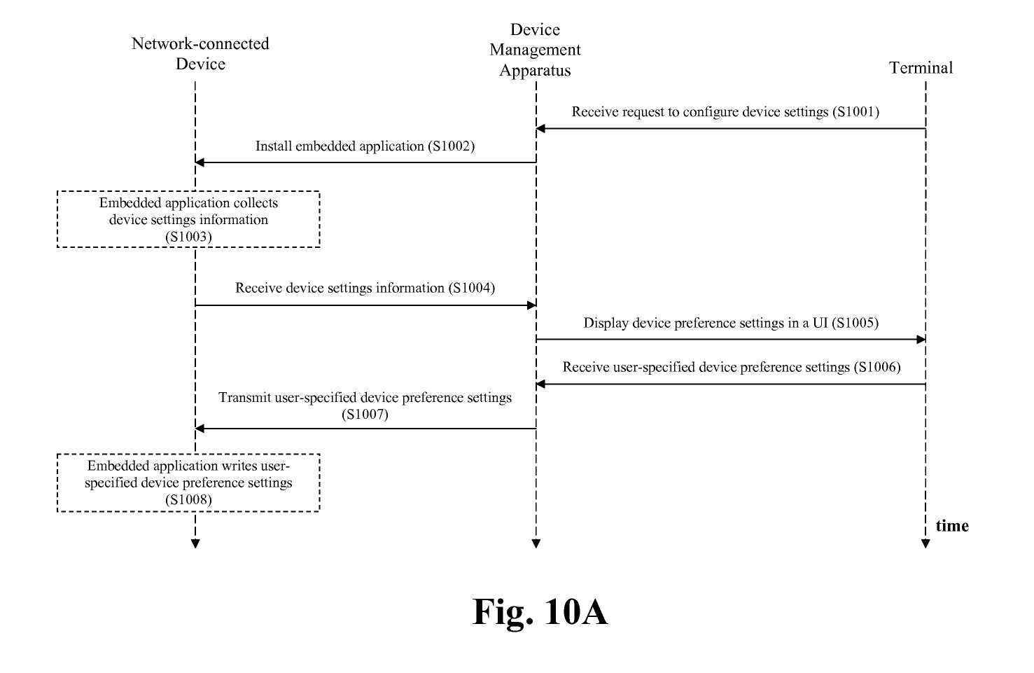

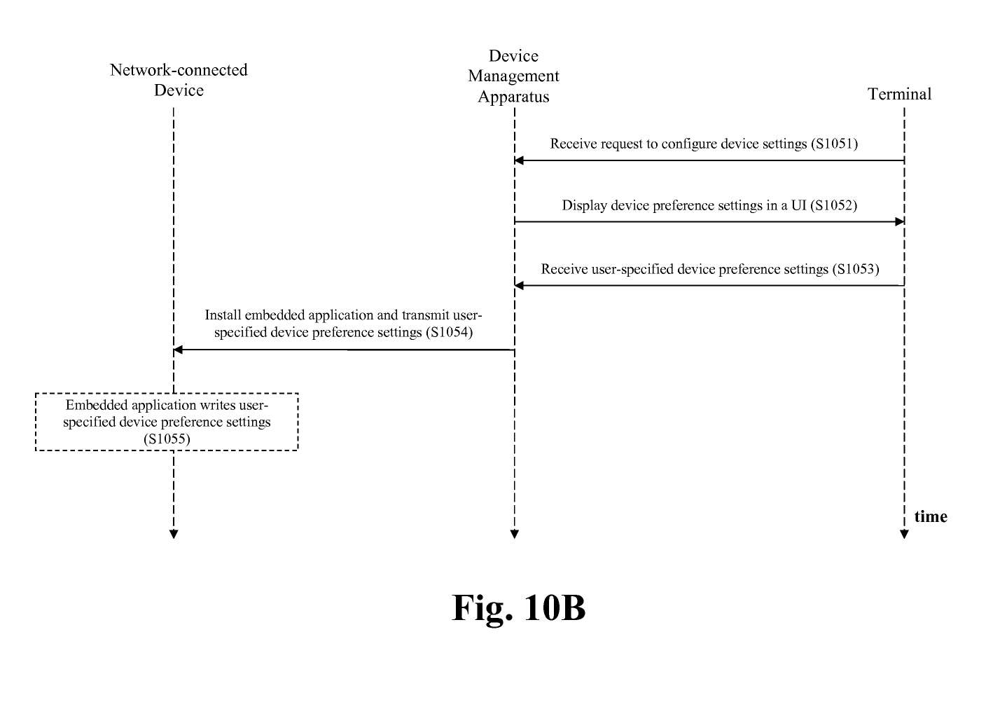

Turning now to FIG. 10A, there is shown a work flow in a method performed by a device management apparatus, such as illustrated in FIG. 1A, according to an exemplary embodiment.

When the device management apparatus receives a user request to configure device preference settings of a network-connected device (step S1001), the device management apparatus communicates an embedded application (which is, for example, stored on an internal storage unit or an external storage unit accessible by the device management apparatus via a network) to the network-connected device and causes the embedded application to be installed on the network-connected device (step S1002). When the embedded application is installed on the network-connected device, the embedded application collects device settings information from the network-connected device (step S1003), and communicates the collected device settings information to the device management apparatus (step S1004). The device management apparatus displays to the terminal a user interface including device preference settings of the network-connected device, based on the device settings information received from the embedded application (step S1005). The user configures the device preference settings for the network-connected device via the displayed user interface, and the user-specified device preference settings are communicated to the device management apparatus, for example, upon the user activating the “OK” button and terminating the settings session (step S1006). The device management apparatus transmits the user-specified device preference settings to the network-connected device (step S1007) and causes the embedded application installed on the network-connected device to write the user-specified device preference settings on the network-connected device (step S1008).

Turning now to FIG. 10B, there is shown a work flow in a method performed by a device management apparatus, such as illustrated in FIG. 1A, according to another exemplary embodiment.

When the device management apparatus receives a user request to configure device preference settings of a network-connected device (step S1051), the device management apparatus displays to the terminal a user interface including device preference settings of the network-connected device, based on, for example, the device settings information stored in a storage unit in association with the network-connected device, such as shown in FIG. 5 (step S1052). The user configures the device preference settings for the network-connected device via the displayed user interface, and the user-specified device preference settings are communicated to the device management apparatus (step S1053).

The device management apparatus causes an embedded application to be installed on the network-connected device and transmits the user-specified device preference settings to the network-connected device (step S1054), and the device management apparatus causes the embedded application installed on the network-connected device to write the user-specified device preference settings on the network-connected device (step S1055).

Thus, in the example of FIG. 10B, the embedded application is installed on the network-connected device after the user has entered the device preference settings via the user interface provided by the device management apparatus.

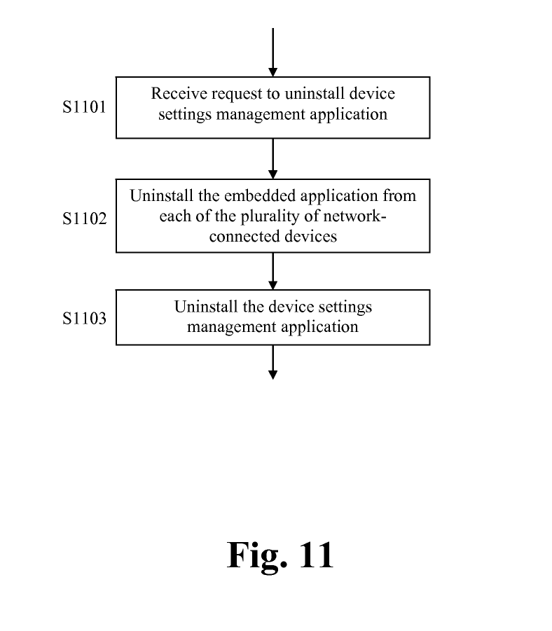

Turning now to FIG. 11, there is shown a flowchart of a method of uninstalling a device settings management application, according to an exemplary embodiment.

When a user request to uninstall the device settings management application (e.g. installed on a terminal device of the user) is received (step S1101), the device settings management application causes the embedded application installed on the plurality of network-devices to be uninstalled from each of the network-connected devices, by, for example, deleting the files associated with, and generated by, the embedded application from the network-devices (step S1102). Then, the device settings management application is uninstalled (e.g. from the terminal of the user) as requested by the user.

Since the embedded application is automatically installed when the user wishes to configure the device preference settings and automatically uninstalled when the user wishes to uninstall the device settings management application, the user does not have to worry about installing or uninstalling the embedded application. Indeed, in this exemplary embodiment, the embedded application is transparent to the user. That is, the embedded application functions without the user being aware of its presence.

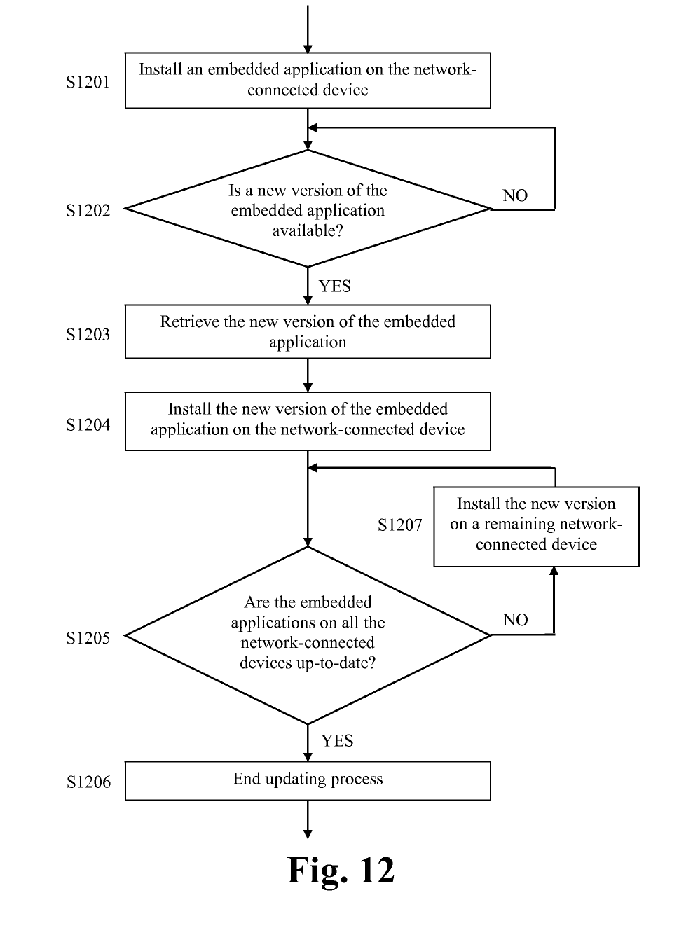

Turning now to FIG. 12, there is shown a flowchart of a method of updating the embedded application, according to an exemplary embodiment.

After the embedded application is installed on the network-connected device (e.g. as discussed with reference to FIG. 10A) (step S1201), it is checked whether a new version of the embedded application is available (e.g. available for download from a web space) (step S1202). For example, the device management application may check for any updates available for the embedded application installed on the network-connected device every time the device management application is opened. Alternatively, the device settings management unit may periodically check for such updates.

If it is determined that a new version of the embedded application is available (YES, S1202), the new version of the embedded application is retrieved (step S1203), and installed on the network-connected device (step S1204).

For example, the device settings management unit may download the new version of the embedded application from a website that maintains a copy of the latest version of the embedded application for download.

In S1205, it is determined whether the embedded applications installed on all the network-connected devices are up-to-date, by, for example, checking the version number of the embedded application installed on each of the network-connected devices. If it is determined that all the embedded applications are up-to-date (YES, S1206), the updating process is ended (step S1206). Otherwise, the new version of the embedded application is installed on a remaining network-connected device having an embedded application that is out-of-date (step S1207), and such process is repeated until the embedded applications on all the network-connected devices in the network environment are up-to-date.

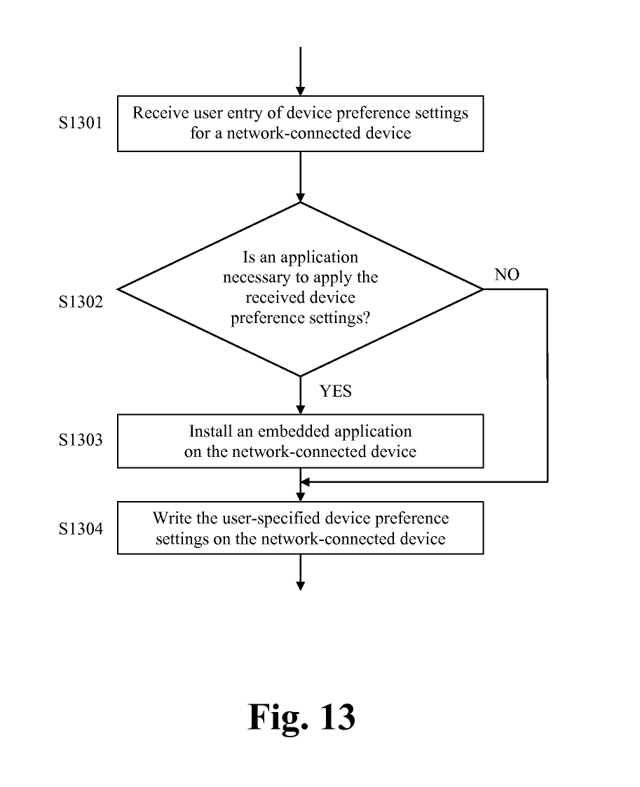

Turning now to FIG. 13, there is shown a flowchart of a method of installing the embedded application, according to an exemplary embodiment.

When a user entry of device preference settings for a network-connected device is received (step S1301), it is checked whether the applying such device preference settings to the network-connected device requires a separate application (e.g. embedded application) (step S1302).

If it is determined that a separate application is needed in order to apply the user-specified device preference settings to the network-connected device (YES, S1301), an embedded application is communicated to and installed on the network-connected device (step S1303), and the embedded application is caused to write the user-specified device preference settings on the network-connected device (step S1304).

On the other hand, if it is determined that a separate application is not needed to apply the user-specified device preference settings to the network-connected device (NO, S1302), the user-specified device preference settings are written on the network-connected device without installing the embedded application on the network-connected device (step S1304).

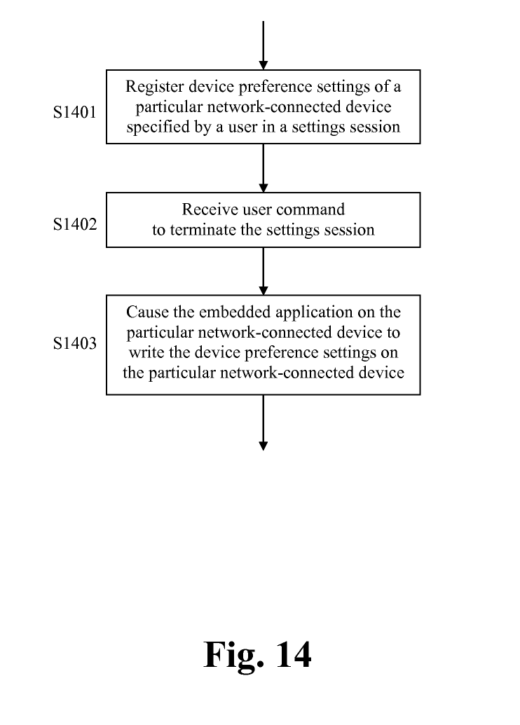

Turning now to FIG. 14, there is shown a flowchart of a method of writing device preference settings on the network-connected device, according to an exemplary embodiment.

The device preference settings specified by the user for one or more particular network-connected devices in a settings session (e.g. user interface shown in FIG. 7C) are registered by the device settings management unit (step S1401). For example, the device preference settings specified by the user via the user interface is temporarily stored in a storage unit (either terminal side or in the device settings management unit). Once the user command to terminate the settings session (e.g. by activating the “OK” button in the user interface shown in FIG. 7C) is received by the device settings management unit (step S1402), the device settings management unit causes the embedded application installed on each of the particular network-connected devices to write the user-specified device preference settings on the particular network-connected devices (step S1403).

In the aforementioned aspects of the present disclosure, a user can remotely configure all of the device preference settings of a plurality of network-connected devices via a device settings management unit without having to resort to other less convenient methods of configuring device preference settings depending on the device preference settings to be configured.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A device management apparatus configured to manage a plurality of network-connected devices through a network, said device management apparatus comprising:
a network communication unit that communicates through the network with the plurality of network-connected devices; and
a device settings management unit that causes the network communication unit to communicate through the network with each specific network-connected device of the network-connected devices to cause an embedded application corresponding to the specific device to be installed on the specific device, the device settings management unit including
a user interface for a user to specify device preference settings for one or more of the network-connected devices, wherein
the device settings management unit causes the network communication unit to communicate the user-specified device preference settings through the network to said one or more of the network-connected devices and causes the embedded application on each particular network-connected device of said one or more of the network-connected devices to write the user-specified device preference settings on the particular network-connected device.

2. The device management apparatus of claim 1, wherein the user interface of the device settings management unit displays all of the device preference settings of the specific network-connected device, and permits the user of the device management apparatus to specify and modify any of said all of the device preference settings of the specific network-connected device.

3. The device management apparatus of claim 1, wherein the user interface of the device settings management unit displays all of the device preference settings of multiple network-connected devices of a same device type, and permits the user of the device management apparatus to specify any of said all of the device preference settings of the multiple network-connected devices of the same device type and instruct the device management apparatus to cause the specified settings to be applied to each of the multiple network-connected devices of the same device type.

4. The device management apparatus of claim 1, wherein the device settings management unit causes the embedded application to be communicated by the network communication unit through the network to, and installed on, the specific network-connected device, after the user of the device management apparatus instructs the device management apparatus to configure the device preference settings of one or more of the network-connected devices.

5. The device management apparatus of claim 1, wherein the user-specified device preference settings entered through the user interface of the device settings management unit, communicated through the network to said each particular network-connected device and written on the particular network-connected device by the embedded application on the particular network-connected device include preference settings of one or more device users of the particular network-connected device.

6. The device management apparatus of claim 1, wherein the user-specified device preference settings entered through the user interface of the device settings management unit, communicated through the network to said each particular network-connected device and written on the particular network-connected device by the embedded application on the particular network-connected device include service settings of the particular network-connected device by a service technician or administrator.

7. The device management apparatus of claim 1, wherein the device settings management unit, upon user entry through the user interface of the device settings management unit of an instruction to uninstall the device settings management unit from the device management apparatus, communicates through the network communication unit with the plurality of network-connected devices and causes the embedded application to be uninstalled from each of the plurality of network-connected devices.

8. The device management apparatus of claim 1, wherein the device settings management unit, upon availability of a new version of the embedded application, retrieves the new version of the embedded application, and causes the new version of the embedded application to be communicated through the network communication unit to, and to be installed on, each of the plurality of network-connected devices.

9. The device management apparatus of claim 1, wherein the device settings management unit, upon user entry, via the user interface of the device settings management unit, of the device preference settings of said one or more of the network-connected devices, causes the embedded application, which is transparent to the user, to be communicated by the network communication unit through the network to, and installed on, the specific network-connected device.

10. The device management apparatus of claim 1, wherein the device settings management unit registers the device preference settings specified by the user of the device management apparatus in a settings session, and after the user terminates the settings session, causes the user-specified device preference settings to be communicated through the network to said each particular network-connected device and written on the particular network-connected device by the embedded application on the particular network-connected device.

11. The device management apparatus of claim 1, wherein the embedded application on the specific network-connected device collects device settings information and communicates the collected device settings information through the network to the device settings management unit of the device management apparatus.

12. A device management system comprising:
a network communication unit that communicates through a network with a plurality of network-connected devices;
an embedded application management unit that causes the network communication unit to communicate an embedded application through the network to each specific network-connected device amongst the network-connected devices and cause the embedded application to be installed on the specific device,
the embedded application installed on the specific network-connected device being configured to collect device settings information;
a device settings user interface for a user to specify device preference settings for one or more of the network-connected devices; and
a device settings management unit that causes the collected device settings information received from the embedded application to be reflected by the device settings user interface, causes the network communication unit to communicate the user-specified device preference settings through the network to the embedded application on each particular network-connected device of said one or more of the network-connected devices, and causes the embedded application on the particular network-connected device to write the user-specified device preference settings on the particular network-connected device.

13. The device management system of claim 12, wherein the device settings user interface displays the device preference settings of the particular network-connected device based on the collected device settings information received from the embedded application on the particular network-connected device.

14. The device management system of claim 12, wherein the embedded application management unit causes the embedded application to be communicated by the network communication unit through the network to, and installed on, the specific network-connected device, after the user of the device management apparatus enters one or more of the device preference settings for the specific network-connected device.

15. The device management system of claim 12, wherein the embedded application management unit, upon user entry through the device settings user interface of an instruction to uninstall the device settings management unit, communicates through the network communication unit with the plurality of network-connected devices and causes the embedded application to be uninstalled from each of the plurality of network-connected devices.

16. The device management system of claim 12, wherein the embedded application management unit, upon availability of a new version of the embedded application, retrieves the new version of the embedded application, and causes the new version of the embedded application to be communicated through the network communication unit to, and to be installed on, each of the plurality of network-connected devices.

17. The device management system of claim 12, wherein the device settings management unit registers the device preference settings specified by the user of the device management apparatus in a settings session, and after the user terminates the settings session, causes the user-specified device preference settings to be communicated through the network to said each particular network-connected device and written on the particular network-connected device by the embedded application on the particular network-connected device.

18. A method of managing a plurality of network-connected devices through a network, said method comprising:
communicating an embedded application through the network to each specific network-connected device of the plurality of network-connected devices;
displaying device preference settings, through a user interface on a user terminal, to a user;
receiving device preference settings specified by the user for one or more of the network-connected devices;
communicating the user-specified device preference settings through the network to said one or more of the network-connected devices; and
writing, by the embedded application on each particular network-connected device of said one or more of the network-connected devices, the user-specified device preference settings on the particular network-connected device.

19. The method of claim 18, further comprising:
installing the embedded application on the specific network-connected device after the user enters one or more of the device preference settings for the specific network-connected device;
installing, upon availability of a new version of the embedded application, the new version of the embedded application on each of the plurality of network-connected devices; and
uninstalling, upon user entry of an instruction to uninstall the device settings management unit, the embedded application from each of the plurality of network-connected devices.

20. The method of claim 18, further comprising:
registering the device preference settings specified by the user in a settings session;
communicating the device preference settings through the network to said each particular network-connected device; and
writing, by the embedded application on the particular network-connected device, the device preference settings on the particular network-connected device.
